(19) United States
(12) Patent Application Publication
(10) Pub. No.: US 2010/0274396 A1
(43) Pub. Date: Oct. 28, 2010

(54) THERMOELECTRIC CLIMATE CONTROL

(75) Inventors: Jihui Yang, Lakeshore (CA); Gregory A. Major, Farmington Hills, MI (US)

Correspondence Address: Cantor Colburn LLP-General Motors, 20 Church Street, 22nd Floor, Hartford, CT, 06103, US

(73) Assignee: GM GLOBAL TECHNOLOGY OPERATIONS, INC., Detroit, MI (US)

(21) Appl. No.: 12/429,532

(22) Filed: Apr. 24, 2009

(51) Int. Cl. G05B 15/00; F25B 21/02; B60H 1/32; G05D 23/00

(52) U.S. Cl. 700/278; 62/3.2; 62/239; 236/51

(57) ABSTRACT

Thermoelectric modules are disposed to be connected to a vehicle coolant system and to an air handling system to provide localized climate control and passenger compartment climate control. Vehicle coolant acts as a heat sink in cooling mode and a heat source in heating mode in embodiments. A system controller in embodiments is disposed to monitor an input for a signal that a monitored climate characteristic has departed from a predefined range of values.

### BACKGROUND OF THE INVENTION

The subject matter disclosed herein relates to heating, ventilation, and cooling (HVAC) or climate control systems, and in particular to climate control systems for vehicles employing distributed thermoelectric modules.

Climate control systems are used with vehicles to provide heating or cooling to maintain an interior passenger compartment at a desired temperature while the vehicle is in use. Traditionally, climate control systems involved a separate heating system and cooling system. The heating system absorbed latent heat produced by the vehicle such as the vehicle's internal combustion engine for example. Air ducts transfer the latent heat from a central location, such as a heater core for example, to vents in the passenger compartment. Cooling systems have typically used a thermodynamic refrigeration cycle that moved a working fluid between a compressor, an evaporator and a condenser to absorb heat from ventilation air. The cooled air was then transferred to the passenger compartment vents from a centralized evaporator through air ducts. Generally with these types of systems the temperature control of the passenger compartment was limited to a single temperature setting since there is a single source of heating or cooling.

The air ducts, vents, heating lines and refrigeration lines occupy a considerable amount of space in the vehicle, therefore the configuration is not easily modifiable due to the potential interferences with other vehicle components. Where the manufacturer provided vehicles to different markets with different requirements, such as placing the drivers wheel on the right versus the left side of the vehicle for example, the different designs for the climate control system were needed. Thus, the incurred increased investment and operating expenses in maintaining multiple designs.

Further, while traditional climate control systems worked well with vehicles having internal combustion engines, issues arise with vehicles having advanced propulsion systems, such as, for example, direct injection gasoline/diesel internal combustion engines (ICEs), hybrid electric/ICE, fuel cell and electric powered. These vehicles may have no or insufficient waste heat to be used for heating the passenger compartment of a vehicle. Resistance heating in such vehicles is generally less efficient than desired to optimize fuel/charge consumption and only provides heat. Electrically powered conventional air conditioning systems are also less efficient than desired and lead to less than optimal power consumption.

Accordingly, while existing vehicle climate control systems are suitable for their intended purpose, there remains a need for improvements in providing passenger compartment climate control that may be sized appropriately for the vehicle, is independent of the type of propulsion system used, and is more energy efficient.

### BRIEF DESCRIPTION OF THE INVENTION

According to one aspect of the invention, a thermoelectric climate control module for use in a distributed thermoelectric climate control system is provided. The module includes a housing with a thermoelectric element. A conduit is arranged in thermal communication with a first side of the thermoelectric element, the conduit having a respective first port through the housing and a respective second port through the housing. A passage is arranged in thermal communication with a second side of the thermoelectric element, the passage being disposed in fluid communication with the housing.

According to another aspect of the invention, a climate control system is provided. The climate control system includes a plurality of thermoelectric modules fluidly connected to a compartment of a vehicle and to a coolant supply. Each thermoelectric module includes a thermoelectric element. A coolant tube is arranged in thermal communication with a first side of the thermoelectric element and thermally connected to the coolant supply. An air conduit is arranged in thermal communication with a second side of the thermoelectric element and fluidly connected to the compartment. A controller is coupled for communication with each of the plurality of thermoelectric modules, the system controller including a processor responsive to executable computer instructions when executed on the processor. The controller executes a method including monitoring a first input for a first signal from at least one first sensor disposed to monitor a respective climate characteristic. The method further includes a first action of the at least one thermoelectric module is initiated when a respective monitored climate characteristic departs from a desired range.

According to yet another aspect of the invention, a climate control system for a passenger compartment of a vehicle is provided. The climate control system includes a radiator and a fluid loop fluidly coupled to the radiator. A first thermoelectric module having a first thermoelectric device thermally coupled to the fluid loop and a first heat exchanger thermally coupled to the first thermoelectric device. A first conduit is disposed in fluid communication with the first heat exchanger.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic illustration of a thermoelectric module according to embodiments disclosed herein;

FIG. 2 is a schematic illustration of a thermoelectric module according to another embodiment disclosed herein;

FIG. 3A is a schematic illustration of a thermoelectric module for defrosting or defogging a window according to embodiments disclosed herein;

FIG. 3B is a schematic illustration of another thermoelectric module for defrosting or defogging a window according to embodiments disclosed herein;

FIG. 4 is a schematic illustration of a climate control system according to embodiments disclosed herein;

FIG. 5 is a schematic illustration of a climate control system according to another embodiment disclosed herein;

FIG. 6 is a plan view illustration of a vent with local temperature control according to an embodiment disclosed herein; and,

FIG. 7 is a flow diagram illustration of a method of operating a climate control system according to an embodiment disclosed herein.

The detailed description explains embodiments of the invention, together with advantages and features, by way of example with reference to the drawings.

### DETAILED DESCRIPTION OF THE INVENTION

Embodiments as disclosed herein provide a distributed thermoelectric HVAC (TEHVAC) system that offers advantages in enhanced efficiency, compact size, modularity, ease of installation, and improved quality, reliability, and durability. The embodiments provided herein may also enable distinctive passenger/interior compartment styling; accommodate left & right hand drive vehicles with low cost tooling for ducts; enable individual temperature control at each vent; require less power per than a central HVAC system; reduced noise, vibration, and harshness; and improved fuel economy.

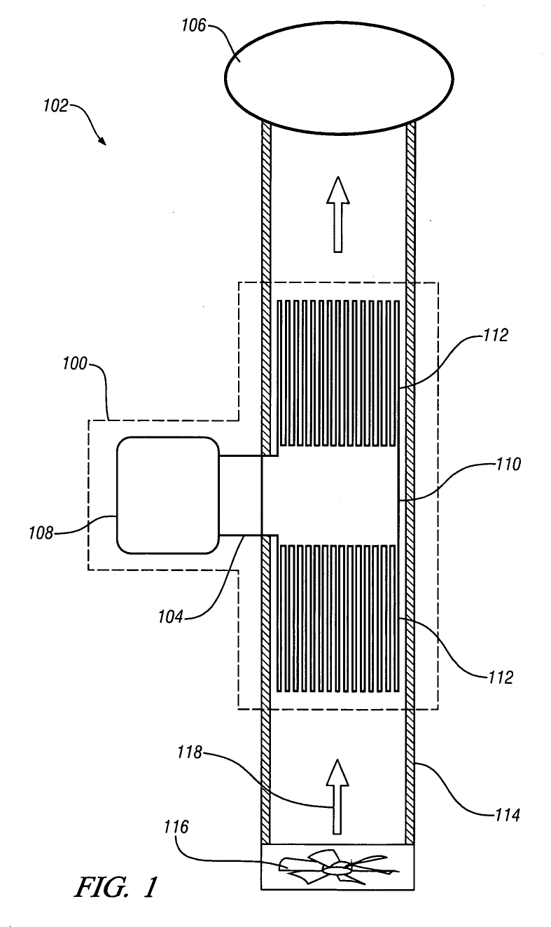

FIG. 1 shows an example of a thermoelectric (TE) module 100 that can be used in a TEHVAC system 102 according to an embodiment as disclosed herein. In the example shown, at least one thermoelectric device 104 provides heating, cooling, and ventilation at a respective desired location 106. For example, in embodiments installed in a passenger car, a thermoelectric module 100 is installed to enable temperature control in a passenger compartment.

The thermoelectric device 104 uses a thermoelectric effect to allow the direct conversion of electric voltage to create temperature differences between opposite sides of the device 104. The sign or direction of the applied voltage determines the direction of heat transfer. Therefore, the thermoelectric device 104 may be used for either heating or cooling.

The TE module 100 also includes a coolant tube 108 thermally coupled to one side of the thermoelectric device. As will be discussed in more detail below, the coolant tube 108 is arranged to absorb heat from the thermo electric device 104 during a cooling mode. In one embodiment, the coolant tube forms a single fluid loop that couples multiple TE modules 100. Opposite the coolant tube 108, a heat sink or heat distribution device 110 is thermally coupled to the thermo electric device 104. One or more heat exchangers 112, such as fins or plates for example, are coupled to the heat distribution device 1 10. The heat distribution device 110 and heat exchangers 112 cooperate to transfer thermal energy to and from a ventilation area, such as an air conduit or duct 114 for example.

In the embodiment illustrated in FIG. 1, air is moved through a passage formed by the duct 114 in the direction indicated by arrow 118 and past the heat exchanger 112 by a fan 116. The air exits the duct 114 through a vent (not shown) and is transferred into the area 106 where the temperature is being controlled, such as a passenger/interior compartment of a vehicle for example. It should be appreciated that when the TE module 100 is in a cooling mode, thermal energy is transferred from the air to the cooling tube 108. Conversely, when the TE module 100 is in heating mode, thermal energy is transferred through the thermoelectric device 104 to the air. Further, the duct 114 may be arranged to flow air from within a vehicle passenger compartment (recirculation mode) or from a location outside the vehicle.

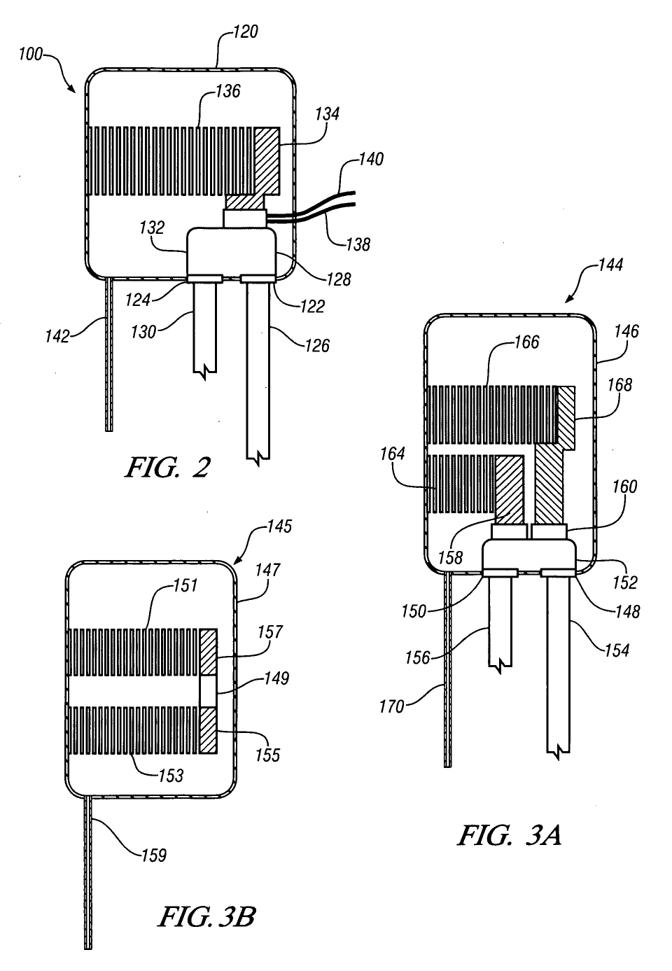

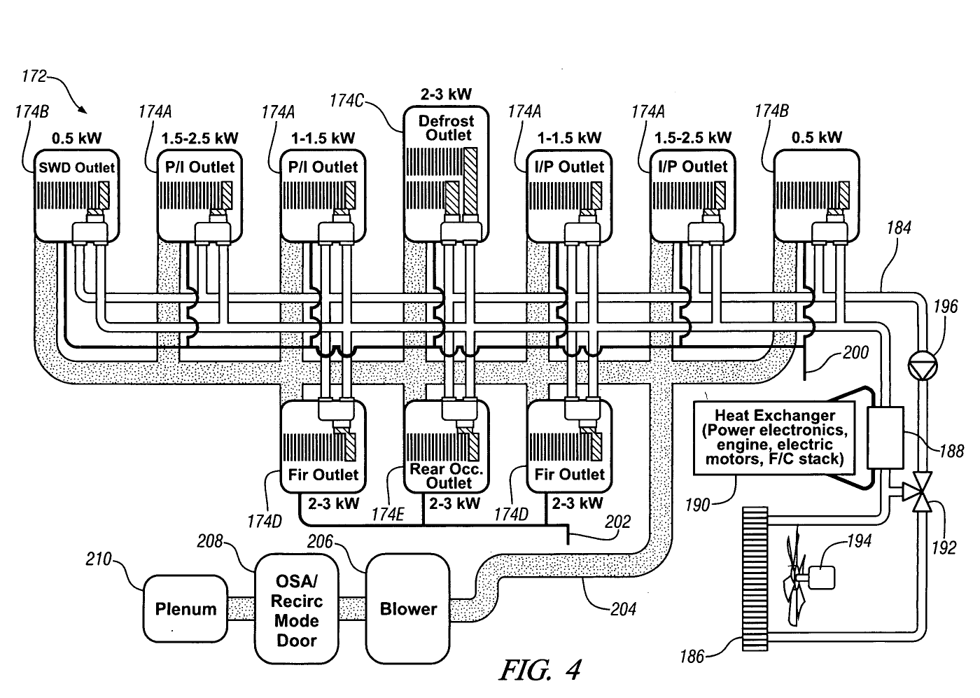

Another embodiment of the TE module 100 is shown in FIG. 2. In this embodiment, the TE module 100 includes a housing 120. The housing 120 is adapted to fit within, or be coupled inline with the duct 114 (FIG. 1). In this configuration, the ends of the housing 120 are open to allow air to flow from the duct 114 through the housing 120 and then back into the duct 114 where it is transferred to the area 106 (FIG. 1). In the exemplary embodiment, the duct 114 is insulated to minimize the loss or gain of thermal energy of air in the duct 114 between the housing 120 and the area 106. The housing 120 also includes an inlet port 122 and an outlet port 124. The inlet port 122 is sized to allow a conduit 126 to enter the housing 120 and couple to the cooling tube 128. Similarly, the outlet port 124 is sized to allow a conduit 130 to couple to the cooling tube 128. In one embodiment, the cooling tube 128 and the conduits 126, 130 are a single conduit, such as a u-shaped conduit for example. As will be discussed in more detail below, the conduits 126, 130 couple to a heat exchanger (FIG. 4) to dissipate thermal energy absorbed from the heat exchangers 136 when in cooling mode.

Thermally coupled to the cooling tube 128 within the housing 120 is a thermoelectric device 132. The thermoelectric device 132 includes a pair of electrical connections 138, 140 that are arranged to reversibly apply a voltage across the thermoelectric device 132 to induce a temperature difference across the device 132. A heat transfer device 134, such as a heat sink for example, is thermally coupled to one side of the thermoelectric device 132 opposite the cooling tube 128. A heat exchanger 136 is thermally coupled to heat transfer device 134. In one embodiment, the heat exchanger 136 includes a plurality of fins or plates. In another embodiment, the heat exchanger 136 and the heat transfer device 134 are integrated into a single unitary device.

The TE module 100 may also include a drain or condenser tube 142. The condenser tube 142 is fluidly coupled to the interior of the housing 120 to provide a path for egress of water from housing 120 of water that may condense on the heat exchanger 136, the heat transfer device 134, the thermoelectric device 132 or the cooling tube 128. In one embodiment, the housing 120 includes a sloped surface (not shown) that encourages accumulated water to flow into the condenser tube 142.

Another embodiment of a TE module 144 for use with deicing, defrosting or defogging windows is shown in FIG. 3A. In this embodiment, the TE module 144 includes a housing 146. The housing 146 is adapted to couple with a conduit, such as conduit 114 (FIG. 1) for example, such that air from the conduit 114 flows through the interior of the housing 146 before being transferred to the area 106 (FIG. 1). Similar to the embodiment described above, the housing 146 includes an inlet port 148 and an outlet port 150. The ports 148, 150 allow conduits 154, 156 to couple with cooling tube 152. In one embodiment, the conduits 154, 156 and the cooling tube 152 are a single integrated conduit, such as a u-shaped conduit for example.

When defrosting or defogging a window, it is desirable to use dry air, meaning air with a low humidity level. To achieve air with the desired properties, the TE module 144 includes a first thermoelectric device 158 and a second thermoelectric device 160. The thermoelectric devices 158, 160 are thermally coupled to the cooling tube 152.

The first thermoelectric device 158 is coupled to a first heat exchanger 164 by a heat sink or first heat transfer device 162. Similarly, the second thermoelectric device 160 is coupled to a second heat exchanger 166 by a heat sink or second heat transfer device 168. The first heat exchanger 164 and the second heat exchanger 166 may be positioned in a stacked arrangement as shown in FIG. 3A, or alternatively, in a linear arrangement wherein the air from the conduit 114 (FIG. 1) passes through/over the first heat exchanger 164 before the second heat exchanger 164. A drain or condensation line 170 is coupled to the housing 146 to allow the removal of water that may accumulate due to condensation on the heat exchangers 162, 166.

During operation, the TE module 144 first dehumidifies the air received from conduit 114 by absorbing heat from the air with heat exchanger 164. In one embodiment, this is achieved by operating the thermoelectric device 158 in a cooling mode which creates a temperature differential across the thermoelectric device 158 resulting in a temperature at the interface of the heat transfer device 162 that is colder than the interface with the cooling tube 152. This allows the absorption of heat from the first heat transfer device 162 and the heat exchanger 164. Once the temperature of the first heat exchanger 164 is below the dew point of the air, moisture in the air will condense into liquid form on the first heat exchanger 164. It should be appreciated that this condensation process has the effect of lowering the humidity of the air. The condensed water flows under the influence of gravity to the bottom of the housing 146 where it is drained via condensation line 170.

After the air is dried by the first heat exchanger 164, the air passes through/over the second heat exchanger 166. Since the temperature of the air needs to be warm, at least above 32° F. (0° C.). In order to raise the temperature of the air, the second heat exchanger 166 is heated by operating the second thermoelectric device 160 in a heating mode. When in the heating mode, a temperature differential across the second thermoelectric device 160 is configured with the temperature of the second heat transfer device 168 being higher than the interface of the cooling tube 152. This allows the conduction of thermal energy into the second heat transfer device 168 and the second heat exchanger 166. With the air heated by the second heat exchanger 166, the air may then be transferred to the area 106 (FIG. 1), such as a windshield for example, to either defrost or defog the window.

It should be appreciated that the embodiment of FIG. 3A may also be operated to simultaneously use both of the thermoelectric devices 158, 160 in a heating mode, or a cooling mode to provide additional capacity to the TE module 144.

Another embodiment of a TE module 145 is illustrated in FIG. 3B. The TE module 145 is similar to the embodiment of FIG. 3A in that it may be used to defrost or defog a window. The TE module 145 includes a housing 147 that is adapted to couple with a conduit, such as conduit 114 (FIG. 1) for example, such that air from the conduit 114 (FIG. 1) flows through the interior of the housing 147 before being transferred to the area 106 (FIG. 1). In one embodiment, the housing 147 and the conduit 114 are a single, integral component with the TE module arranged therein.

Within the housing is positioned a thermoelectric device 149 coupled to a first heat exchanger 151 and second heat exchanger 153 by heat transfer devices 155, 157 respectively. The heat transfer devices 155, 157 are thermally coupled to opposite sides of the thermoelectric device 149 to allow transfer of thermal energy from one heat exchanger to the other. As such, unlike the embodiments discussed above, in this embodiment, no cooling tube is used.

To provide defrosting or defogging operation, the thermoelectric device 149 is operated with one heat exchanger, such as heat exchanger 153 for example, in a cooling mode and the other heat exchanger, such as heat exchanger 151 for example, in a heating mode. It should be appreciated that when operated in this manner, the thermoelectric device 149 causes the temperature of the cooling mode heat exchanger to decrease while simultaneously increasing the temperature of the heating mode heat exchanger. As discussed above, once the temperature of the cooling mode heat exchanger (e.g. heat exchanger 153) is below the dew point of the air passing through the housing 147, water from the air will condense on the cooling mode heat exchanger. Similar to the embodiments above, a condensation line 159 is provided to allow removal of the condensed water. It should be appreciated that this condensation process has the effect of lowering the humidity of the air.

The heat removed from the cooling mode heat exchanger is transferred to the heat mode heat exchanger (e.g. heat exchanger 151). This increases the temperature of the heat mode heat exchanger allowing the air passing through/over the heat mode heat exchanger to be warmed. This dehumidified and heated air is then delivered to the area 106 (FIG. 1), such as a front or rear windshield for example, to defrost or defog a window.

It should be appreciated that the housings 120, 146, 147 are sized to be adapted to a vehicle vent conduit. The cross sectional area of the housing would be sized based on a number of factors, such as required discharge temperatures, amount of air flow from the housing, velocity of the air leaving the housing, and pressure drop in the housing for example. Since these vent conduits are typically positioned in locations where there are limitations on over all size, such as a vehicle dashboard, a center console or a door panel for example, the housings 120, 146 generally have a relatively small cross sectional area, such as 6 in² (39 cm²) for example. However, this is for exemplary purposes only, and the claimed invention should not be so limited. This size parameter along with other features described in more detail below provides advantages in that the TE modules 100, 144, 145 may be arranged or distributed throughout the interior/passenger compartment of a vehicle, placing the heating and cooling functionality where it is desired, without the numerous restraints of existing designs that typically have a single heating source (e.g. a heater core) and a single cooling source (e.g. an evaporator).

Referring now to FIG. 4, another embodiment of a distributed climate control system 172 is illustrated. The climate control system 172 may include a passenger/ interior module 174A, side-window-door (“SWD”) module 174B, defrost module 174C, floor module 174D and rear occupant module 174E (the modules 174A-174E collectively referred to herein as “modules 174”). Each of the modules includes at least one thermoelectric device, such as thermoelectric devices 132, 149, 158, 160 discussed above (FIG. 2, FIG. 3A, FIG. 3B). The modules 174 are fluidly coupled to a single fluid loop 184. As will be discussed in more detail below, the loop 184 circulates a working fluid, such as automotive coolant (e.g. ethylene glycol, diethylene glycol, or propylene glycol), water or air for example, from a radiator 186 to each of the modules 174 to either remove thermal energy or provide thermal energy to each of the modules 174 based on their mode of operation.

The modules 174 may have different ratings based upon their thermal output. For example, SWD modules 174B may have a rating of 0.5 kilowatts, while the passenger/interior modules 174A may range from 1 kilowatt to 2.5 kilowatts, while the floor modules 174D and rear occupant modules 174E may range from 2 kilowatts to 3 kilowatts. The defrost modules 174C may have a rating of 1 kilowatt to 1.5 kilowatts for the dehumidifying thermoelectric device 158 and a 3 kilowatt to 4 kilowatt rating for the heater thermoelectric device 160, for example. It should be appreciated that the module 174 rating is based on the intended function and the size of the area being heated and cooled by a module 174.

The fluid loop 184 connects each of the outlets in series to the radiator 186. The fluid loop 184 includes an optional heat exchanger 188 that is thermally coupled to heat generating components 190, such as an internal combustion engine, power electronics, electric motors or fuel cell stacks for example. The heat exchanger 188 transfers thermal energy from the heat generating components 190 to the fluid loop 184. The fluid loop 184 shown in FIG. 4 is in a parallel flow loop configuration. It should be appreciated that the coolant loop may be arranged in other configurations, such as a series flow or a combination of series and parallel flow paths for example, depending on the system size and the desired thermal energy flows. This thermal energy is either dissipated by the radiator 186, such as by using a fan 194 to move air across coils for example, or transferred to the modules 174 to assist the thermoelectric devices 132, 152, 158 during heating mode. In one embodiment, the fluid loop 184 includes a three-way valve 192 that allows the flow of the working fluid to bypass the radiator 186. A check valve 196 prevents the reversal of flow in the loop 184.

Each of the modules 174 also includes a drain or condensation line 198 as described above. The condensation lines of closely located modules 174 may be grouped together into a single condensation line 200 for the modules 174A, the SWD modules 174B and defrost module 174C, a single condensation line 202 for the floor modules 174D and rear occupant modules 174E.

In one embodiment, the climate control system 172 also includes a vehicle air handling system having an air conduit or duct 204 that fluidly connects a fan or blower 206 to each of the modules 174. Opposite the blower 206 a switch or door 208 is provided that allows the air to be drawn from either the ambient environment or from the interior passenger compartment. A plenum 210 is fluidly coupled to the door 208 to maintain a positive pressure on the blower 206. In another embodiment, each module 174 has an individual vent duct 204 with an individual blower 206.

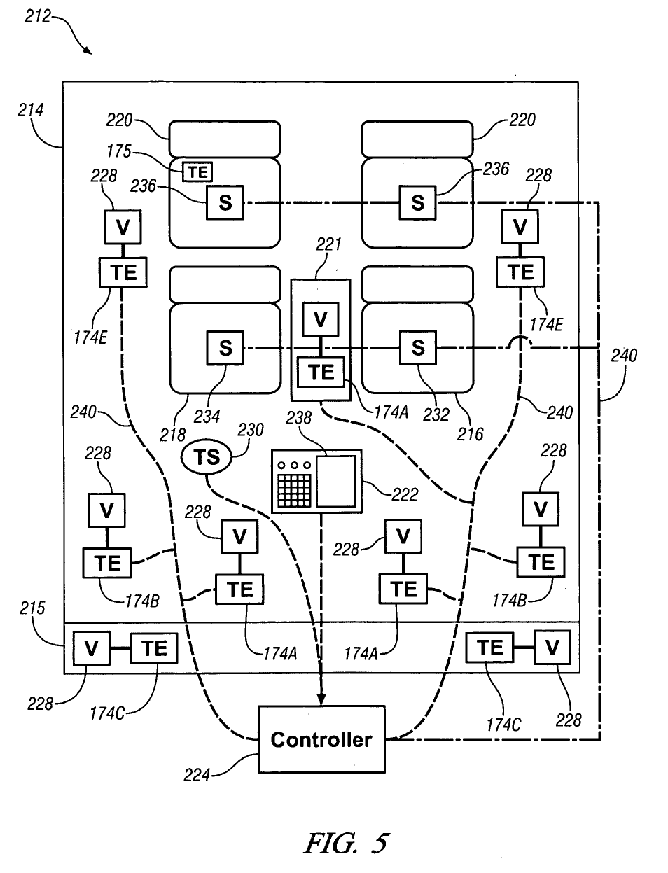

Another embodiment of a climate control system 212 for a vehicle is illustrated in FIG. 5. In this embodiment, a passenger/interior compartment 214 includes a plurality of seats, such as a driver seat 216, a front passenger seat 218, and rear occupant seats 220. In one embodiment, a center console 221 is arranged between the driver seat 216 and the front passenger seat 218. The passenger compartment 214 also includes a user interface 222 arranged adjacent the driver seat 216 and the passenger seat 218, such as in the vehicles dashboard 215. The user interface 222 is coupled to transmit and receive signals from a controller 224.

The climate control system 212 includes a plurality of thermoelectric modules 174 distributed about and fluidly coupled to the passenger/interior compartment 214. The thermoelectric modules 174 may all be identical, or may include different types or sizes of thermoelectric modules, such as those described with respect to the embodiment of FIG. 4. Each of the thermoelectric modules 174 is associated with a vent 228 that allows conditioned air, such as warm, cold or dehumidified air for example, to be transferred into the passenger/interior compartment 214. The thermoelectric modules 174 may be connected to the vents 228 by a conduit for example. In other embodiments, the thermoelectric modules 174 and vents 228 are integrated into a single component. It should be appreciated that in some embodiments, the thermoelectric modules, such as modules 174, such as module 175 for example, may be installed in a vehicle seat, such as seat 220 for example.

Each of the thermoelectric modules 174 is coupled to transmit signals to the controller 224 via data transmission media 240. Data transmission media 240 includes, but is not limited to, twisted pair wiring, coaxial cable, and fiber optic cable. Data transmission media 240 also includes, but is not limited to, wireless, radio and infrared signal transmission systems. In the embodiment shown in FIG. 5, transmission media 240 couples controller 224 to thermoelectric modules 174, climate sensor 230 and occupant sensors 232, 234, 236. Controller 224 is configured to provide operating signals to these components and to receive data from these components via data transmission media 240.

The climate control system 212 also includes one or more sensors, such as but not limited to climate sensor 230, driver sensor 232, passenger sensor 234 and rear occupant sensors 236. In the exemplary embodiment, the climate sensor 230 measures a climate characteristic, such as temperature or humidity for example. The sensors 230, 232, 234, 236 are coupled to transmit signals to the controller 224. The driver sensor 232, passenger sensor 234, and rear occupant sensors 236 detect the presence of a person occupying the seat the sensor is associated with. The controller 224 may use the signal from sensors 232, 234, 236 to determine whether to activate one or more thermoelectric devices 174 that direct conditioned air to this portion of the passenger/interior compartment 214 for example. The controller 224 may further compare the signal from sensor 230 against a set point to determine whether additional heating or cooling is desired.

It should be appreciated that in some embodiments, the climate control system 212 may include multiple temperature sensors 230 distributed within the passenger/interior compartment 214. In these embodiments, the temperature sensors 230 provide feedback to the controller 224 and the controller 224 adjusts the operation of the thermoelectric modules 174 to maintain desired temperatures. Further, in some embodiments, the sensors 232, 234, 236 may be integral with an air bag or a seat belt sensor.

The controller 224 includes a computer processor that receives the signal from a sensor, such as sensor 230 and that is in communication with a computer readable storage medium containing computer executable instruction, such as executable computer code. Additionally, the computer processor may be in communication with one or more storage devices, such as random access memory, nonvolatile memory, or read-only memory for example. Further, in some embodiments, the controller 224 also provides additional functionality to assist the operation of the vehicle, including but not limited to ignition control, transmission control, power distribution, antilock braking systems, and instrument panel control for example.

Therefore, controller 224 can be a microprocessor, microcomputer, a minicomputer, an optical computer, a board computer, a complex instruction set computer, an ASIC (application specific integrated circuit), a reduced instruction set computer, an analog computer, a digital computer, a molecular computer, a quantum computer, a cellular computer, a superconducting computer, a supercomputer, a solid-state computer, a single-board computer, a buffered computer, a computer network, a desktop computer, a laptop computer, or a hybrid of any of the foregoing.

The controller 224 may also be in communication with one or more devices, including, but not limited to, an indicator (not shown), such as a light on a dashboard, a user interface 222 having a display 238 and a communications system, such as a cellular or satellite communications medium for example.

In general, controller 224 accepts data from sensors 230, is given certain instructions for the purpose of comparing the data from sensor 230 to predetermined operational parameters. Controller 224 provides operating signals to thermoelectric modules 174. Controller 224 also accepts data from sensors 232, 234, 236, indicating, for example, whether the where occupants are present in the passenger/interior compartment 214. The controller 224 compares the operational parameters to predetermined variances (e.g. low temperature, high temperature) and if the predetermined variance is exceeded, generates a signal that may be used to change operational parameters of the thermoelectric modules 174 or to indicate an alarm to a driver. Additionally, the signal may initiate other control methods that adapt the operation of the climate control system 212 such as changing the operational state of one or more thermoelectric devices to compensate for the out of variance operating parameter. For example, if sensor 236 does not detect the presence of an occupant, the thermoelectric modules 174E that direct air into the rear portion of the passenger/interior compartment 214 may be deactivated. This provides the advantage of reducing the energy requirements of the climate control system 212 by operating the thermoelectric modules 174 where occupants are present.

The computer program code is written in computer instructions executable by the controller 224, such as in the form of software encoded in any programming language. Examples of suitable programming languages include, but are not limited to, assembly language, VHDL (Verilog Hardware Description Language), Very High Speed IC Hardware Description Language (VHSIC HDL), FORTRAN (Formula Translation), C, C++, C#, Java, ALGOL (Algorithmic Language), BASIC (Beginner All-Purpose Symbolic Instruction Code), APL (A Programming Language), ActiveX, HTML (HyperText Markup Language), XML (eXtensible Markup Language), and any combination or derivative of one or more of these.

In one embodiment, the user interface 222 includes a display 238, such as a liquid crystal display (LCD), organic light emitting diode (OLED), or cathode ray tube (CRT), or other type of display as may be used with computer systems and user interfaces. The user interface 222 may also produce an audible indicator in the interior of the vehicle, such as via the sound generating system, and/or provide information such as the in-car entertainment system for example, via the display 228 or a sound generating system.

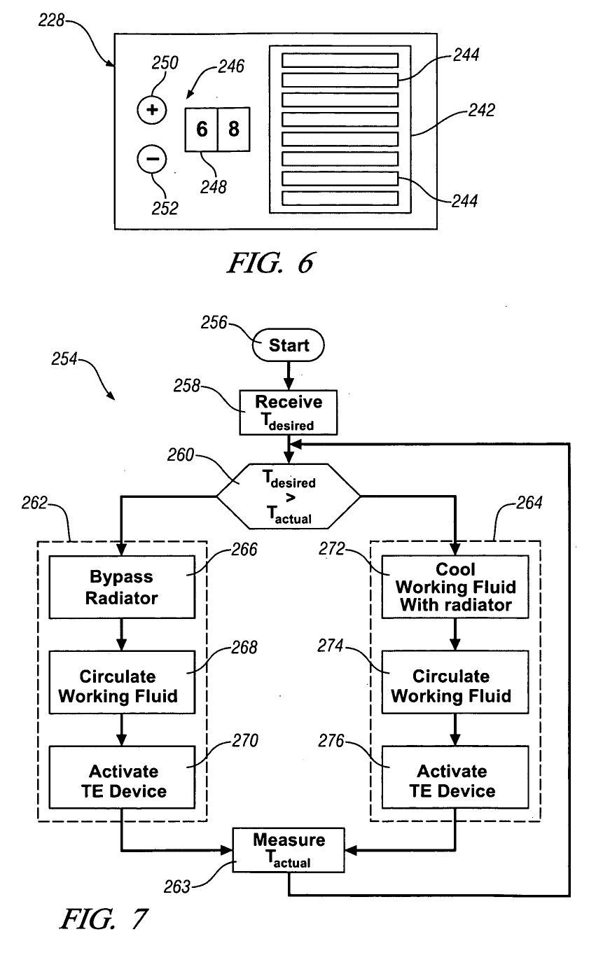

In another embodiment, the user interface 222 may be integrated into the vents 228 as illustrated in FIG. 6. In this embodiment, the vent 228 includes an outlet 242 that includes openings 244, which allow the conditioned air from the thermoelectric modules 174 to enter into the passenger/interior compartment 214. The vent 228 further includes an interface 246 that allows the operator to indicate the desired temperature from the vent 228. In one embodiment, the interface 246 includes a display 248, such as a light emitting diode (LED) for example, and buttons 250, 252. The operation of the thermoelectric device 226 associated with the vent 228, is adjusted by actuating the buttons 250, 252 to the desired temperature. The control of the thermoelectric modules 174 may be from the controller 222 as discussed above, or may be controlled directly by the interface 246. In some embodiments, the vent 228 may also include a temperature sensor (not shown) to provide direct feedback control to the thermoelectric modules 174.

During operation, the operator, such as a driver for example, indicates a desired temperature, such as with the user interface 222 for example. The desired temperature is transmitted to the controller 224, which executes one or more climate control system methods 254 as illustrated in FIG. 7. The method 254 starts in block 256 and proceeds to block 258 where the desired temperature, T_{desired} is received. The method 254 then proceeds to block 260 where the measured temperature (T_{actual}) is compared against the desired temperature, T_{desired}. If the query block 260 returns a positive, meaning the desired temperature (T_{desired}) is higher than the measured temperature (T_{actual}), the method 254 proceeds to heating mode 262 where the thermoelectric modules 174 are configured to increase the temperature of the passenger/interior compartment 214.

If the query block 260 returns a negative, meaning that the desired temperature (T_{desired}) is below the measured temperature (T_{actual}), the method 254 proceeds to cooling mode 264 where the thermoelectric modules 174 are configured to decrease the temperature of the passenger/interior compartment 214. The method 254 periodically samples the air in the passenger/interior compartment 214 to measure the air temperature ((T_{actual}) in block 263 and then loops back to query block 260.

In one embodiment, the heating mode 262 includes a block 266 where the loop 184 is configured to bypassing the radiator 186, such as by switching the valve 192 as illustrated in FIG. 4 for example. When in this configuration, the loop 184 absorbs heat from the heat generating components 190 causing an increase the temperature of the working fluid. The heated working fluid is circulated in block 268 through the loop 184 to each of the thermoelectric modules 174. The heating mode 262 activates the thermoelectric devices, such as thermoelectric device 132 (FIG. 2) for example, as discussed above in block 270 before proceeding to block 262. In some embodiments, where the temperature difference between T_{desired} and (T_{actual}) is small and the vehicle generates a sufficient amount of thermal energy, the heat is transferred from the working fluid by the thermoelectric device without adding any additional heat. In these embodiments, the thermoelectric device acts as a heater core in heating the passenger/interior compartment 214. It should be appreciated that while block 266, block 268 and block 270 are shown as being performed in sequence, these blocks may also be performed in parallel.

In another embodiment, the cooling mode 264 includes a block 272 where the valve 192 is configured to direct the working fluid through radiator 186. This reduces the temperature of the working fluid due to the thermal energy absorbed from the thermoelectric modules 174 and/or heat generating components 190. The cooling mode 264 circulates the working fluid through the loop 184 in block 274 to absorb thermal energy. The cooling mode 264 also activates the thermoelectric devices 262 and/or modules 174 in block 276 to cause the transfer of thermal energy from the air in the conduit 114 to the working fluid as discussed above. It should be appreciated that while block 266, block 268 and block 270 are shown as being performed in sequence, these blocks may be performed in parallel as well.

A method according to the embodiments is realized via, and a system according to the embodiments includes, computer-implemented processes and apparatus for practicing such processes, such as the controller 224 and/or a computer processor. Additionally, an embodiment includes a computer program product including computer executable instructions, such as object code, source code, or executable code, on tangible media, such as magnetic media (floppy diskettes, hard disc drives, tape, etc.), optical media (compact discs, digital versatile/video discs, magneto-optical discs, etc.), random access memory (RAM), read only memory (ROM), flash ROM, erasable programmable read only memory (EPROM), or any other computer readable storage medium on which the computer executable instructions is stored and with which the computer executable instructions can be loaded into and executed by a computer. When the computer executes the computer program code, it becomes an apparatus for practicing the invention, and on a general-purpose microprocessor, specific logic circuits are created by configuration of the microprocessor with computer code segments. A technical effect of the executable instructions is to implement distributed passenger compartment climate control using thermoelectric climate control modules. The modules can be individually controlled by an occupant, zonally controlled by an occupant, and/or controlled by a system controller to minimize power consumption while providing a comfortable environment in the passenger compartment.

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A thermoelectric climate control module for use in a distributed thermoelectric climate control system, the module comprising:
a housing;
a thermoelectric element in the housing;
a conduit in thermal communication with a first side of the thermoelectric element, the conduit having a respective first port through the housing and a respective second port through the housing; and
a passage in thermal communication with a second side of the thermoelectric element, the passage being disposed in fluid communication with the housing.

2. The module of claim 1 wherein the conduit comprises a cooling tube passing through the housing via the first port and the second port, the coolant tube being arranged to dispose a working fluid in thermal communication with the first side of the thermoelectric electric element.

3. The module of claim 2 wherein the coolant tube is disposed for thermal connection to a cooling system of a vehicle in which the module is installed.

4. The module of claim 1 wherein the passage comprises an air conduit disposed to deliver air to the thermoelectric module.

5. The module of claim 4 wherein the air conduit is disposed for connection to an air handling system of the vehicle.

6. The module of claim 4 wherein the air conduit is the housing.

7. The module of claim 1 wherein the housing is disposed for installation in a vehicle seat.

8. The module of claim 1 wherein the housing is disposed for installation in a vehicle dashboard.

9. The module of claim 1 wherein the housing is disposed in a vehicle console.

10. A climate control system comprising:
a plurality of thermoelectric modules fluidly connected to a compartment of a vehicle and to a coolant supply, each thermoelectric module including:
a thermoelectric element;
a coolant tube in thermal communication with a first side of the thermoelectric element and thermally connected to the coolant supply; and,
an air conduit in thermal communication with a second side of the thermoelectric element and fluidly connected to the compartment;
a controller in communication with each of the plurality of thermoelectric modules, the system controller including a processor responsive to executable computer instructions when executed on the processor, the controller executes a method including:
monitoring a first input for a first signal from at least one first sensor disposed to monitor a respective climate characteristic;
initiating a first action of the at least one thermoelectric module when a respective monitored climate characteristic departs from a desired range.

11. The system of claim 10 wherein a respective monitored climate characteristic is temperature in the compartment and the first action is initiating a heating mode when temperature is outside a predefined range.

12. The system of claim 10 wherein a respective monitored climate characteristic is temperature in the compartment and the first action is initiating a cooling mode when temperature is outside a predefined range.

13. The system of claim 10 wherein the method further comprises monitoring a second input for a second signal from a second sensor associated with at least one of the plurality of thermoelectric modules and initiating a second action when the controller receives the second signal indicating that an occupant is present in the compartment, the second action comprising enabling the at least one of the plurality of thermoelectric modules with which the second sensor is associated.

14. The system of claim 10 wherein the method further comprises monitoring a second input for a second signal from a second sensor associated with at least one of the plurality of thermoelectric modules and initiating a second action when the controller receives the second signal indicating that no occupant is present, the second action comprising disabling the at least one of the plurality of thermoelectric modules with which the second sensor is associated.

15. A climate control system for a passenger compartment of a vehicle comprising:
a radiator;
a fluid loop fluidly coupled to the radiator;
a first thermoelectric module, the first thermoelectric module having a first thermoelectric device thermally coupled to the fluid loop and a first heat exchanger thermally coupled to the first thermoelectric device; and,
a first conduit disposed in fluid communication with the first heat exchanger.

16. The climate control system of claim 15 further comprising:
a heat generating component thermally coupled to the fluid loop; and,
a valve fluidly coupled between the heat generating component and the radiator.

17. The climate control system of claim 16 wherein the valve is a three-way valve having a first portion fluidly coupled to the heat generating component, a second portion fluidly coupled to the radiator and a third component fluidly coupled to the first thermoelectric device.

18. The climate control system of claim 15 further comprising a second thermoelectric module, the second thermoelectric module comprising:
a second thermoelectric device thermally coupled to the fluid loop;
a second heat exchanger device thermally coupled to the second thermoelectric device;
a third thermoelectric device thermally coupled to the fluid loop; and,
a third heat exchanger thermally coupled to the third thermoelectric device.

19. The climate control system of claim 18 further comprising a second conduit in fluid communication with the second heat exchanger and the third heat exchanger.

20. The climate control system of claim 19 wherein the second heat exchanger and the third heat exchanger are disposed in a serial relationship in the second conduit.
